(19) United States
(12) Patent Application Publication
(10) Pub. No.: US 2024/0088406 A1
(43) Pub. Date: Mar. 14, 2024

(54) BIPOLAR PLATE AND RESILIENT CONDUCTION MEMBER

(71) Applicant: AFC ENERGY PLC, Cranleigh, Surrey (GB)

(72) Inventors: Richard John CARTWRIGHT, Cranleigh, Surrey (GB); Christopher Thomas REYNOLDS, Cranleigh, Surrey (GB); Neill Devereux MAYNARD, Cranleigh, Surrey (GB); Jody WHEELER, Cranleigh, Surrey (GB)

(21) Appl. No.: 18/261,641

(22) PCT Filed: Jan. 14, 2022
(86) PCT No.: PCT/GB2022/050081

§ 371 Date: Jul. 14, 2023

(30) Foreign Application Priority Data
Jan. 15, 2021 (GB) 2100555.8

(51) Int. Cl. H01M 8/0254; B60L 53/54; B60L 53/57; H01M 4/86; H01M 8/0228; H01M 8/0258; H01M 8/083

(52) U.S. Cl. CPC H01M 8/0254; B60L 53/54; B60L 53/57; H01M 4/8647; H01M 8/0228; H01M 8/0258; H01M 8/083

(57) ABSTRACT

An electrochemical cell (3) for use in a fuel cell stack (1) comprising a resilient electrical conduction member sub-assembly (10, 16) having a first flow plate (5, 9), a second flow plate (6, 8) and a bipolar plate (11, 22). A fluid chamber (17, 19) is created by the first flow plate (5, 9), the second flow plate (6, 8), the bipolar plate (11, 22) and an electrode (13, 18) and has an inflow duct (59, 63) and an outflow duct (61, 65). A resilient electrical conduction member (15, 20) is located within the fluid chamber (17, 19) so that in use, a fluid can flow between the inflow duct (59, 61) and the outflow duct (61, 65). The resilient electrical conduction member (15, 20) is in electrically conductive contact with the bipolar plate (11, 22) and with the electrode (13, 18) via a plurality of electrical contacts (51) and the resilient electrical conduction member (15, 20) is compressed between the bipolar plate (11, 22) and the electrode (13, 18).

The present invention relates to an electrochemical cell with a bipolar design. In particular, the present invention relates to an electrochemical cell for an alkaline fuel cell stack, as well as to a power supply system comprising the alkaline fuel cell stack, such as for charging electric vehicles or powering an electrical device.

Typically, alkaline fuel cells have a monopolar cell design in which adjacent electrochemical cells are oriented in opposite polarity to one another. In a monopolar stack there is a long current path for an electron that is produced in one cell and consumed in an adjacent cell. That current path may be up to half a metre. Furthermore, the surface area available for contact of electrical edge connections between electrochemical cells is small. It is known in the art that bipolar plates can be used, but there are a number of challenges associated with utilisation of them in a practical commercial embodiment of a fuel cell stack. The present invention addresses and overcomes those challenges.

According to the present invention there is provided an electrochemical cell comprising at least one resilient electrical conduction member sub-assembly, the resilient electrical conduction member sub-assembly comprising a first flow plate with a first electrical contact aperture and a second flow plate with a second electrical contact aperture, wherein the first flow plate and the second flow plate are in abutment with each other, a bipolar plate with an electrically conductive surface, the bipolar plate covering the first electrical contact aperture in the first flow plate, and a first fluid tight seal provided around the bipolar plate, so that no fluid can pass through the first electrical contact aperture, an electrode, the electrode covering the second electrical contact aperture in the second flow plate, a fluid chamber created by the first flow plate, the second flow plate, the bipolar plate and the electrode, the fluid chamber having an inflow duct and an outflow duct which each pass through at least one of the first flow plate and the second flow plate, and a resilient electrical conduction member located within the fluid chamber in a fluid path between the inflow duct and the outflow duct so that in use, a fluid can flow between the inflow duct and the outflow duct through the resilient electrical conduction member, the resilient electrical conduction member has a first side that is in electrically conductive contact with the bipolar plate and a second side that is in electrically conductive contact with the electrode, such as to allow an electric current to flow between the bipolar plate and the electrode and the first side and the second side are each provided with a plurality of electrical contacts, wherein the resilient electrical conduction member is compressed between the bipolar plate and the electrode, so that the electrical contacts are held against the electrically conductive surface of the bipolar plate and the electrode. This arrangement is particularly advantageous because connecting the electrochemical cells together with the resilient electrical conduction members greatly reduces the current path from the production of an electron in one electrochemical cell, to consumption of that electron in the adjacent electrochemical cell. This avoids the problem associated with monopolar fuel cell stacks in which an electron may have to travel up to half a metre between reaction sites. Furthermore, the problem experienced with monopolar fuel cell stacks of a small surface area for the edge electrical connections is overcome by the relatively large surface area for electrical connections provided by the resilient electrical conduction members.

Preferably, the resilient electrical conduction member has a first set of electrical contacts on a first side and a second set of electrical contacts on a second side, the first and second sets of electrical contacts having a space between them within which is located an attachment element that attaches the first and second sets of electrical contacts to each other and being electrically connected to each other by a flexible conductor, wherein the resilient electrical conductor has at least one fluid flow path passing through the space between its first side and its second side, which, in use enables fluid to flow across it the resilient electrical conduction member.

Preferably, the resilient electrical conduction member is a current collector and a flow field.

Preferably, the electrical contacts, the attachment element and the flexible conductor are all elastically compressible.

Preferably, the electrical contacts, the attachment element and the flexible conductor are all elastically compressible and are all formed from an electrically conductive material.

Preferably, the electrical contacts, the attachment element and the flexible conductor are all elastically compressible, are all formed from an electrically conductive material and are all part of an integral component.

Preferably, the resilient electrical conduction member is made from a metal and the fluid flow path is created by a plurality of flow apertures.

Preferably, the resilient electrical conduction member is made from an elastically compressible metal mesh. The metal mesh may be a knitted mesh. In some embodiments, the knitted mesh has an ordered structure. A metal mesh provides a number of advantages, including that it facilitates multiple flow paths through each of the air chamber and the fuel chamber and thus restricts the flow through those chambers as little as possible.

The resilient electrical conduction member could also be made from a number of other types of material, for example from an electrically conductive open pore foam, for example a polymer foam containing electrically conductive elements, or a corrugated perforated metal sheet.

Preferably, the elastically compressible metal mesh of the resilient electrical conduction member is provided with corrugations arranged so that the peaks of the corrugations are located on the first side and the troughs are located on the second side of the resilient electrical conduction member, the parts of the metal mesh coincident with the peaks and the troughs forming the electrical contacts and the parts of the metal mesh between the peaks and the troughs forming the attachment element and the flexible conductor.

Preferably, the electrode is a flexible electrode.

Preferably, the electrode is a flexible gas diffusion electrode.

Preferably, the flexible gas diffusion electrode comprises three layers sandwiched together, a first outer layer of an electrically conductive woven mesh, a middle layer and a second outer layer containing a catalyst, the first outer layer being in electrical contact with the resilient electrical conduction member. This arrangement differs from conventional electrode design, for example because in such conventional designs the outer surface of the first outer layer is often coated in a non-conductive material and thus it is not possible to make an electrically conductive contact with those outer surfaces.

Preferably, the electrode is contained within the electrochemical cell and does not protrude past the external perimeter of the second flow plate. This is advantageous because it reduces the size of the electrodes and thus the amount of material needed to manufacture them, for example it enables a reduction in the amount of metal used. It also facilitates a structural arrangement in which metal components of the fuel cell stack can be electrically isolated from an electrolyte manifold system which reduces shunt current which would otherwise reduce efficiency and could lead to accelerated corrosion of certain fuel cell stack components.

Preferably, the bipolar plate is a non-porous thin plate made from metal.

Preferably, the rearward electrolyte flow plate and the forward electrolyte flow plate abut each other and create between them an electrolyte chamber having an electrolyte inflow duct and an electrolyte outflow duct, wherein an electrode support is located within the electrolyte chamber and supports the rearward electrode and the forward electrode and is provided with an electrolyte flow path to facilitate the flow of electrolyte across the electrolyte chamber from the inflow duct to the outflow duct. In some embodiments, the resilient electrical conduction member is a current collector and a flow field. As such, it plays a role in transferring current from one cell to an adjacent cell, and furthermore the ordered structure of the resilient electrical conduction member creates one or more fluid flow channels which influence the movement of gas across the electrochemical cell, as it flows from the relevant inlet to the relevant outlet.

Preferably, the flow plates are rectangular, generally flat and have a thickness of approximately 3 mm.

In one embodiment, the electrochemical cell comprises an air flow plate electrical conductor sub-assembly, wherein the first flow plate is an air flow plate with a first electrical contact aperture formed by an air chamber aperture, the second flow plate is a rearward electrolyte flow plate with a second electrical contact aperture formed by a rearward electrolyte chamber aperture, wherein the air flow plate and the rearward electrolyte flow plate are in abutment with each other, wherein the bipolar plate is a rearward bipolar plate covering the air chamber aperture in the air flow plate, wherein the electrode is a rearward electrode covering the rearward electrolyte chamber aperture in the rearward electrolyte flow plate, the fluid chamber is an air chamber created by the air flow plate, the rearward electrolyte flow plate, the rearward bipolar plate and the rearward electrode, the air chamber having an air inflow duct and an air outflow duct which each pass through at least one of the air flow plate and the rearward electrolyte flow plate, and a rearward resilient electrical conduction member located within the air chamber in a fluid path between the air inflow duct and the air outflow duct so that in use, air can flow between the air inflow duct and the air outflow duct through the rearward resilient electrical conduction member, the rearward resilient electrical conduction member has a first side that is in electrically conductive contact with the rearward bipolar plate and a second side that is in electrically conductive contact with the rearward electrode, such as to allow an electric current to flow between the rearward bipolar plate and the rearward electrode and the first side and the second side are each provided with a plurality of electrical contacts, wherein the rearward electrical conduction member is compressed between the rearward bipolar plate and the rearward electrode, so that the electrical contacts are held against the rearward bipolar plate and the rearward electrode.

In another embodiment, the electrochemical cell comprises a fuel flow plate electrical conductor sub-assembly, wherein the first flow plate is a fuel flow plate with a first electrical contact aperture formed by an fuel chamber aperture, the second flow plate is a forward electrolyte flow plate with a second electrical contact aperture formed by a forward electrolyte chamber aperture, wherein the fuel flow plate and the rearward electrolyte flow plate are in abutment with each other, wherein the bipolar plate is a forward bipolar plate covering the fuel chamber aperture in the fuel flow plate, wherein the electrode is a forward electrode covering the forward electrolyte chamber aperture in the forward electrolyte flow plate, the fluid chamber is a fuel chamber created by the fuel flow plate, the forward electrolyte flow plate, the forward bipolar plate and the forward electrode, the fuel chamber having a fuel inflow duct and a fuel outflow duct which each pass through at least one of the fuel flow plate and the forward electrolyte flow plate, and a forward resilient electrical conduction member located within the fuel chamber in a fluid path between the fuel inflow duct and the fuel outflow duct so that in use, fuel can flow between the fuel inflow duct and the fuel outflow duct through the forward resilient electrical conduction member, the forward resilient electrical conduction member has a first side that is in electrically conductive contact with the forward bipolar plate and a second side that is in electrically conductive contact with the forward electrode, such as to allow an electric current to flow between the forward bipolar plate and the forward electrode and the first side and the second side are each provided with a plurality of electrical contacts, wherein the forward electrical conduction member is compressed between the forward bipolar plate and the forward electrode, so that the electrical contacts are held against the forward bipolar plate and the forward electrode.

Preferably, the first flow plate is an air flow plate and the air flow plate has a bipolar plate recess surrounding the air chamber aperture on its rearward facing side, the rearward bipolar plate is located within the bipolar plate recess.

Preferably, the rearward bipolar plate has an electrical connector and the air flow plate has an electrical connector recess within which the electrical connector is located and the rearward facing surface of the bipolar plate is flush with the rearward facing surface of the air flow plate.

Preferably, the rearward electrolyte flow plate and the forward electrolyte flow plate each have an electrode recess within which are located the rearward electrode and the forward electrode respectively.

According to a second aspect of the present invention there is provided a fuel cell stack comprising a plurality of electrochemical cells according to the first aspect of the present invention.

According to a third aspect of the present invention there is provided a power supply system for charging or powering an electrical device, comprising a fuel cell stack according to the second aspect of the present invention, and a power supply control system electrically connected to the fuel cell stack, and having a connector mechanism, operable to electrically connect the power supply control system to an electrical device.

In some example arrangements, the power supply system of the third aspect of the present invention may comprise an ammonia cracker system, for processing ammonia to produce hydrogen gas, and a fuel conveyor channel connecting the ammonia cracker system to the fuel cell stack, operable to convey the hydrogen gas from the ammonia cracker system to the fuel cell stack. The fuel gas may consist predominantly of hydrogen, where 99.999% is hydrogen. Alternatively, the percentage of hydrogen might be 99.95%, or 99%. It is also envisaged that the fuel could be ˜75% hydrogen, ˜25% nitrogen with up to 1,000 parts per million of ammonia. The hydrogen may be supplied by an ammonia cracker system, as mentioned above, or it may be supplied by a steam methane reformer, which can utilise methane or biomethane. The hydrogen may also be supplied by an electrolyser. Hydrogen produced using an ammonia cracker system might have a composition of ˜75% hydrogen, ˜25% nitrogen and 0 to ˜1,000 parts per million of residual ammonia.

According to a fourth aspect of the present invention there is provided an electric vehicle charging station comprising a power supply system according to the third aspect of the present invention. In use, an electric vehicle can draw up next to the electric vehicle charging station and an electrical connection can be made between the electric vehicle and the electric vehicle charging station in order to transfer electrical energy to the electric vehicle, for example to charge the batteries on the electric vehicle.

The present invention will be described here with reference to the following figures.

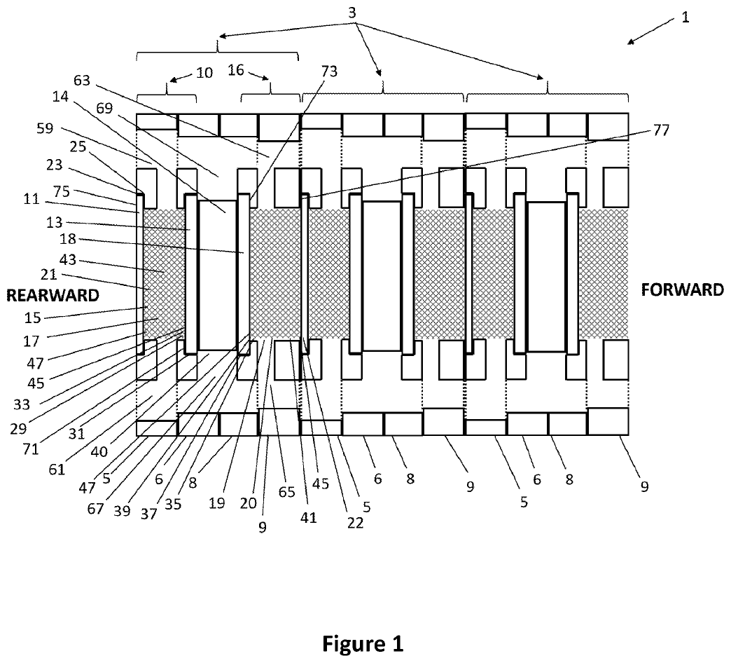

FIG. 1 is a schematic illustration of a cross-section of three electrochemical cells of a fuel cell stack;

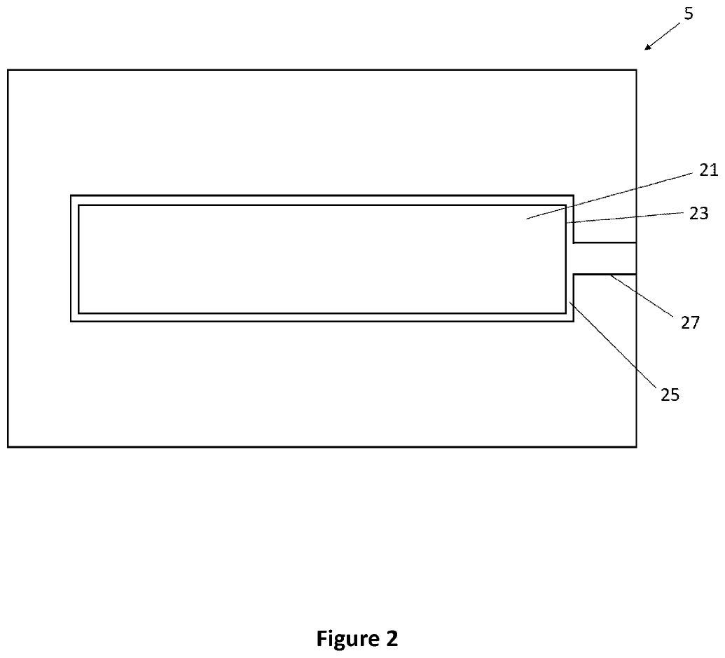

FIG. 2 is a schematic illustration of the rearward facing side of an air flow plate;

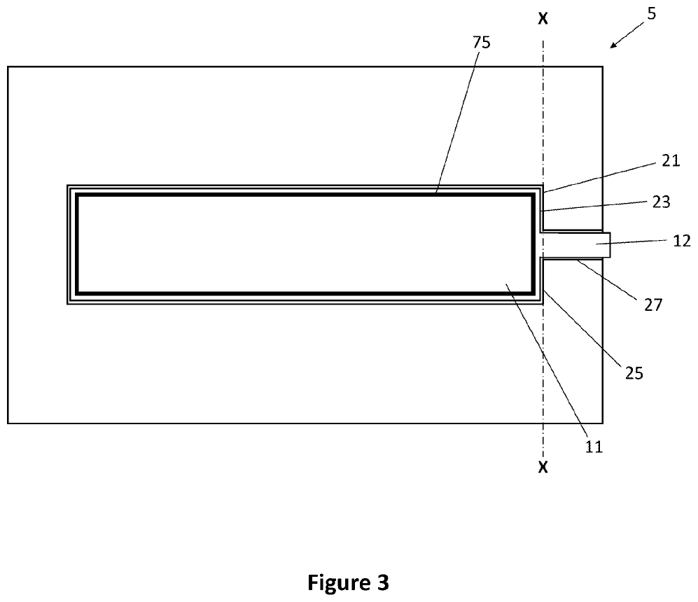

FIG. 3 is a schematic illustration of the rearward facing side of an air flow plate with a bipolar plate located adjacent to it;

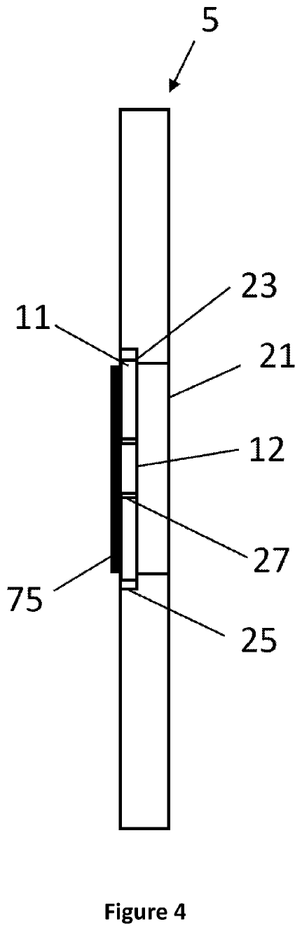

FIG. 4 is a schematic illustration of a cross-section through the air flow plate and the bipolar plate along the line X-X in FIG. 3;

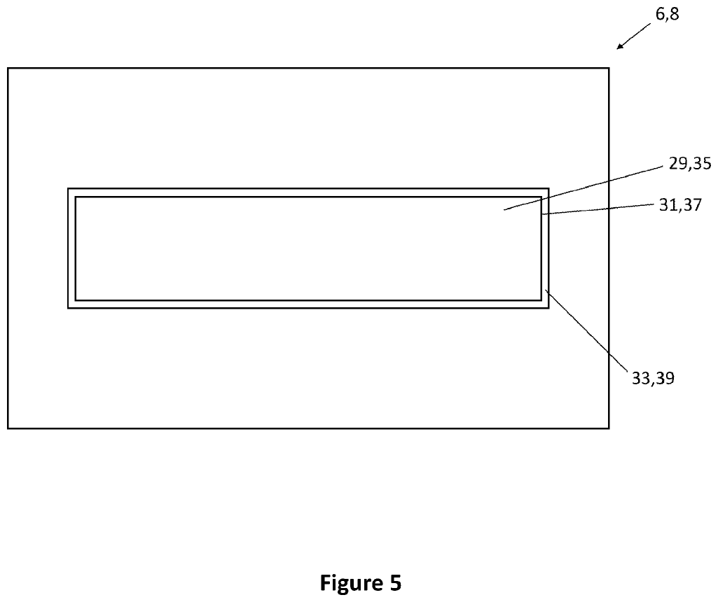

FIG. 5 is a schematic illustration of the forward facing side of a rearward electrolyte flow plate;

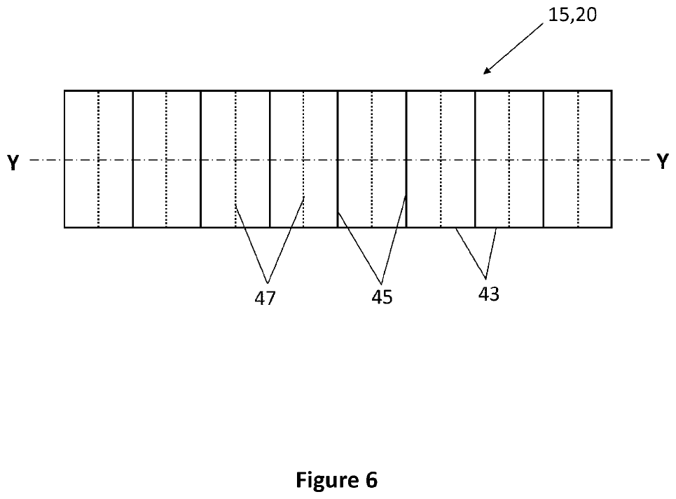

FIG. 6 is a schematic illustration of a rearward facing side of a compressible electrical contact;

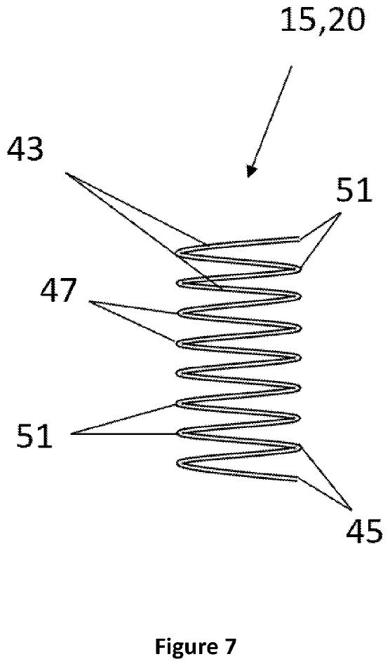

FIG. 7 is a schematic illustration of a cross-section through the compressible electrical contact along the line Y-Y in FIG. 6;

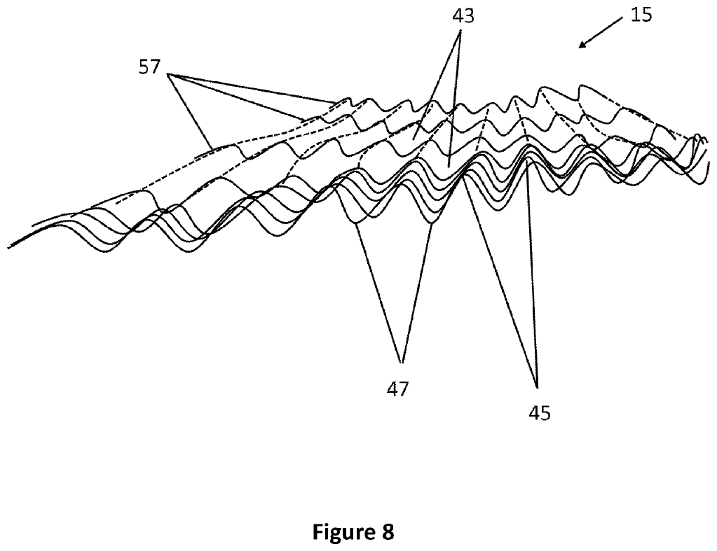

FIG. 8 is a perspective schematic view of a compressible electrical contact spring, showing only some of the wires from which it is constructed;

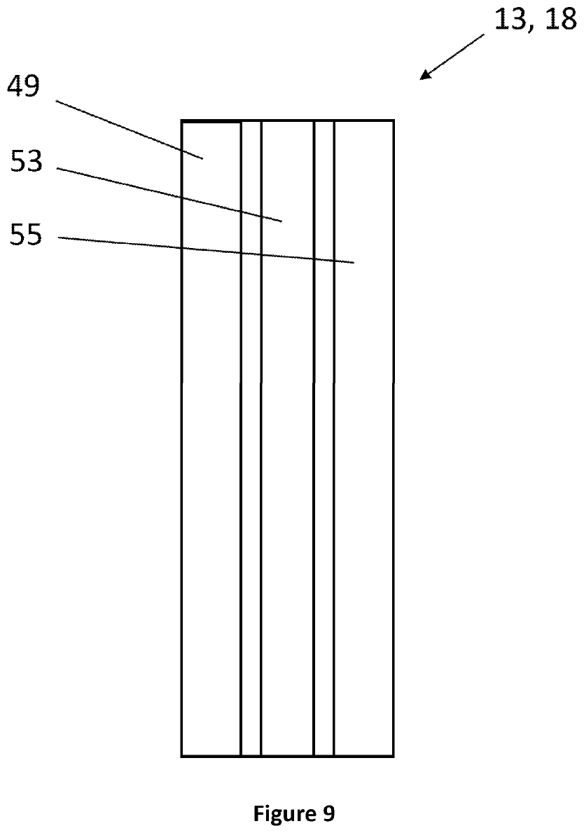

FIG. 9 is a schematic illustration of a cross-section through an electrode; and

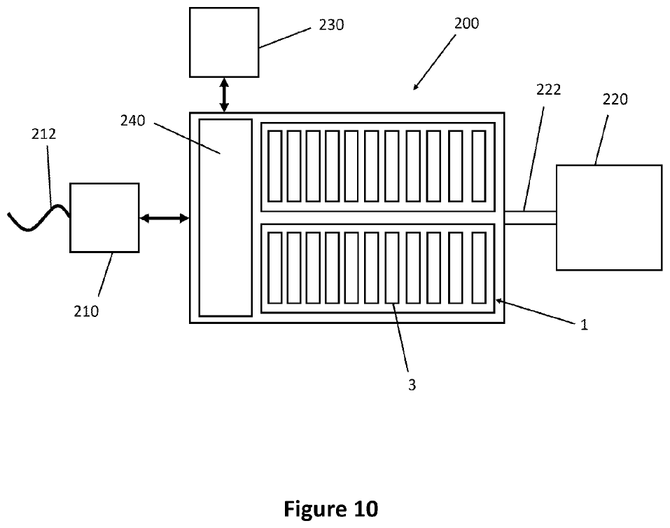

FIG. 10 is a block diagram of an example power supply system for charging an electric vehicle.

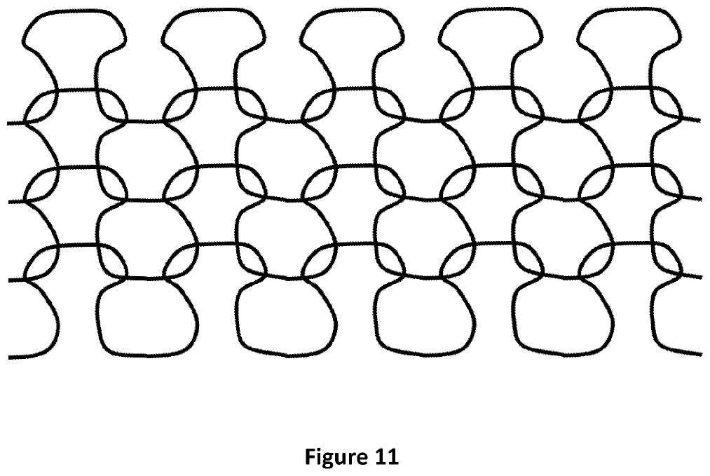

FIG. 11 is a schematic diagram showing a knitted mesh.

An arrangement of electrochemical cells 3 in a fuel cell stack 1 according to the present invention is shown in FIG. 1. The left hand side of the illustrated fuel cell stack 1 is the rearward side and the right hand side is the forward side. The figure shows only three electrochemical cells 3 of a fuel cell stack 1. In practice, a fuel cell stack 1 would comprise many more, for example more than fifty electrochemical cells 3. The electrochemical cells 3 are shown in cross-section and the inflows to and outflows from the electrochemical cells 3 are shown. The figure is schematic and the arrangement of those inflows and outflows has been chosen for the ease of showing all of them in a single cross-section. The illustrated arrangement is not necessarily representative of the relative positioning of the inflows and outflows that would occur in a real fuel cell stack 1.

Each electrochemical cell 3 is made up of an arrangement of an air flow plate 5, a rearward electrolyte flow plate 6, a forward electrolyte flow plate 8, a fuel flow plate 9, a rearward bipolar plate 11, a forward bipolar plate 22, a rearward electrical contact spring 15, a forward electrical contact spring 20, a rearward gas diffusion electrode 13, a forward gas diffusion electrode 18 and an electrode support 14. The plates 5,6,8,9 are rectangular, generally flat and relatively thin, made of a polymer material, have a forward face and a rearward face and four edge faces that define the perimeter of the plates 5,6,8,9. The plates 5,6,8,9 have a complementary external profile so that they can be fitted together to form an electrochemical cell 3. The forward and rearward faces of the plates 5,6,8,9, are each provided with various features, such as apertures and recesses, as will be described in detail below. The plates 5,6,8,9 are different to each other and are orientated in the arrangement so that the air flow plate 5 abuts the rearward electrolyte flow plate 6 which in turn abuts a forward electrolyte flow plate 8, which in turn abuts a fuel flow plate 9. To construct the fuel cell stack 1 the electrochemical cells 3 are arranged so that the fuel flow plate 9 of one electrochemical cell 3 abuts the air flow plate 5 of an adjoining electrochemical cell 3.

Each electrochemical cell 3 has a rearward end at which is located an air flow plate 5 and a forward end at which is located a fuel flow plate 9. A rearward bipolar plate 11 provided adjacent to the air flow plate 5, rearward gas diffusion electrode 13 is provided adjacent to the rearward electrolyte flow plate 6 and a forward gas diffusion electrode 18 is provided adjacent to the forward electrolyte flow plate 8. A forward bipolar plate 22 is provided adjacent to the fuel flow plate 9. An electrode support 14 is provided between the rearward and forward gas diffusion electrodes 13,18. The rearward and forward bipolar plates 11, 22 are rectangular, very thin, for example 0.3 mm in thickness, and have an electrical connector 12, as shown in FIGS. 3a and 3b, that extends out from one of the short sides. A rearward electrical contact spring 15 is located between the rearward bipolar plate 11 and the rearward gas diffusion electrode 13 and a forward electrical contact spring 20 is located between the forward gas diffusion electrode 18 and a forward bipolar plate 22 of the adjoining electrochemical cell 3. Within each electrochemical cell 3 are contained two electrical conductor sub-assemblies 10,16. The air flow plate electrical conductor sub-assembly 10 comprises a rearward bipolar plate 11, an air flow plate 5, a rearward electrical contact spring 15, a rearward electrolyte flow plate 6 and a rearward gas diffusion electrode 13. The fuel flow plate electrical conductor sub-assembly 16 comprises a forward bipolar plate 22, a fuel flow plate 9, a forward electrical contact spring 20, a forward electrolyte flow plate 8 and a forward gas diffusion electrode 18. In a fuel cell stack 1, adjacent electrochemical cells 3 share a bipolar plate 11,22. The forward bipolar plate 22 of a forward electrochemical cell 3 is also the rearward bipolar plate 11 of a rearward electrochemical cell 3.

The air flow plate 5 is formed from a rectangular sheet of a polymer material, as shown in FIG. 2. FIG. 2 shows the rearward facing side of the air flow plate 5. It has a width greater than its height and it is relatively thin, for example 3 mm to 4 mm in thickness. A rectangular air chamber aperture 21 is provided through the entire thickness of the air flow plate 5 and forms part of an air chamber 17. The air chamber aperture 21 is located at the midpoint of the height of the air flow plate 5, the long side of the air chamber aperture 21 is parallel with the long side of the air flow plate 5 and its short side is parallel with the short side of the air flow plate 5. A shoulder 23 is provided around the periphery of the air chamber aperture 21 in the rearward facing side of the air flow plate 5. The shoulder 23 forms a bipolar plate recess 25 that extends partway through the air flow plate 5 to a depth that is at least as great as the thickness of the rearward bipolar plate 11. The bipolar plate recess 25 is also provided with an electrical connector recess 27 that extends from the right hand side (when looking at the rearward facing side of the air flow plate 5) of the bipolar plate recess 25 to the right hand side of the air flow plate 5 and that extends partway through the air flow plate 5 to a depth that is at least as great as the thickness of the electrical connector 12. The air chamber 17 has an air inflow duct 59 at the top and an air outflow duct 61 at the bottom.

The bipolar plate recess 25 has a width and a height that is slightly greater than the width and the height of the rearward bipolar plate 11, so that the rearward bipolar plate 11 fits within it, as shown in FIG. 3 and FIG. 4. The rearward bipolar plate 11 sits within the bipolar plate recess 25 so that its rearward facing surface is flush with the rearward facing side of the air flow plate 5. A fluid tight seal 75 is provided between the rearward facing side of the rearward bipolar plate 11 and the forward facing side of a rearward fuel flow plate 9. Likewise, a fluid tight seal 77 is provided between the rearward facing side of the forward bipolar plate 22 and the forward facing side of a forward fuel flow plate 9 (in a fuel cell stack 1, the fluid tight seal 75 and the fluid tight 77 are the same component, because the bipolar plates 11,22 of adjacent electrochemical fuel cells 3 are shared, as explained above). The electrical connector 12 extends from the right hand side of the rearward bipolar plate 11 by a distance so that it extends past the external perimeter of the air flow plate 5.

The rearward and forward electrolyte flow plates 6, 8 are each formed from a rectangular sheet of a polymer material, as shown in FIG. 5. FIG. 5 is representative of the forward facing side of the rearward electrolyte flow plate 6 and the rearward facing side of the forward electrolyte flow plate 8. The electrolyte flow plates 6, 8 have a width that is greater than their height and are relatively thin.

A rectangular rearward electrolyte chamber aperture 29 is provided through the entire thickness of the rearward electrolyte flow plate 6 and on its rearward side forms part of the air chamber 17. The rearward electrolyte chamber aperture 29 is located at the midpoint of the height of the rearward electrolyte flow plate 6, the long side of the air rearward electrolyte chamber aperture 29 is parallel with the long side of the rearward electrolyte flow plate 6 and the short side is parallel with the short side of the rearward electrolyte flow plate 6. A shoulder 31 is provided around the periphery of the rearward electrolyte chamber aperture 29 in the forward facing side of the rearward electrolyte flow plate 6 and the shoulder 31 forms an electrode recess 33 that extends partway through the rearward electrolyte flow plate 6 to a depth that is at least as great as the thickness of the rearward gas diffusion electrode 13. The rearward gas diffusion electrode 13 is fixed into the electrode recess 33 by a fluid tight seal 71.

A rectangular forward electrolyte chamber aperture 35 is provided through the entire thickness of the forward electrolyte flow plate 8 and on its forward side forms part of a fuel chamber 19. The forward electrolyte chamber aperture 35 is located at the midpoint of the height of the forward electrolyte plate 8, the long side of the forward electrolyte chamber aperture 35 is parallel with the long side of the forward electrolyte flow plate 8 and the short side is parallel with the short side of the forward electrolyte flow plate 8. A shoulder 37 is provided around the periphery of the forward electrolyte chamber aperture 35 in the rearward facing side of the forward electrolyte flow plate 8 and the shoulder 37 forms an electrode recess 39 that extends partway through the forward electrolyte flow plate 8 to a depth that is at least as great as the thickness of the forward gas diffusion electrode 18. The forward gas diffusion electrode 18 is fixed into the electrode recess by a fluid tight seal 73. The fuel chamber 19 has a fuel inflow duct 63 at the top and a fuel outflow duct 65 at the bottom.

An electrolyte chamber 40 is provided between the forward electrolyte flow plate 8 and the rearward electrolyte flow plate 6. The electrolyte chamber 40 has an electrolyte inflow duct 67 at the bottom and an electrolyte outflow duct 69 at the top.

The fuel flow plate 9 is formed from a rectangular sheet of a polymer material, has a width greater than its height and is relatively thin. A rectangular fuel chamber aperture 41 is provided through the entire thickness of the hydrogen plate 9. The fuel chamber aperture 41 is located in the centre of the forward facing side of the forward hydrogen flow plate 9, the long side of the fuel chamber aperture 41 is parallel with the long side of the fuel flow plate 9 and the short side is parallel with the short side of the fuel flow plate 9.

A portion of the rearward electrical contact spring 15 is shown in FIGS. 6 and 7. The forward electrical contact spring 20 is the same as the rearward electrical contact spring 15 and so the following description applies to it as well. The rearward electrical contact spring 15 is made from a rectangular piece of corrugated open metal mesh. Corrugations 43 in the mesh run along the depth of the rectangle, so that their peaks 45 and troughs 47 run vertically, through the full height of the air chamber 17. The distance between the peaks 45 and the troughs 47 defines the depth of the rearward electrical contact spring 15 and it is elastically deformable, so that when a force is applied to its surface in a direction between the peaks 45 and the troughs 47, i.e. when it is compressed between the bipolar plate 11 and the rearward gas diffusion electrode 13, the depth of the rearward electrical contact spring 15 will decrease and it will apply a force to the rearward bipolar plate 11 and to the rearward gas diffusion electrode 13.

The rearward electrical contact spring 15 is located within the air chamber 17 and the forward electrical contact spring 20 is located within the fuel chamber 19.

The rearward electrical contact spring 15 within the air chamber 17 is arranged so that the peaks 45 contact the rearward facing side of the rearward gas diffusion electrode 13, that is adjacent to the rearward electrolyte flow plate 6, and the troughs 47 contact the forward facing side of the rearward bipolar plate 11. The width and height of the rearward electrical contact spring 15 are selected so that it is a close fit within the rearward air chamber aperture 21 of the air flow plate 5 and the rearward electrolyte chamber aperture 29 of the rearward electrolyte flow plate 6.

The forward electrical contact spring 20 within the fuel chamber 19 is arranged so that the peaks 45 contact the rearward side of the forward bipolar plate 22 and the troughs 47 contact the forward facing surface of the rearward gas diffusion electrode 13 that is adjacent to the forward electrolyte plate 8. The width and height of the forward electrical contact spring 20 are selected so that it is a close fit within the forward electrolyte chamber aperture 35 of the forward electrolyte flow plate 8 and the fuel chamber aperture 41 of the hydrogen flow plate 9.

In a relaxed state of the rearward electrical contact spring 15, its depth, i.e. the horizontal distance between the peaks 45 and the troughs 47 is greater than the separation of the rearward bipolar plate 11 and the rearward gas diffusion electrode 13 in the assembled electrochemical fuel cell 3. Likewise, the depth of the forward electrical contact spring 20 is greater than the separation of the forward bipolar plate 22 and the forward gas diffusion electrode 18. When the electrochemical cell 3 is assembled, by clamping together the rearward and forward bipolar plates 11,22 the air flow plate 5, the electrolyte flow plates 6,8 and the fuel flow plate 9, the rearward and forward electrical contact springs 15,20 are subject to a compressive force in a direction perpendicular to their peaks 45 and troughs 47. The horizontal distance between the peaks 45 and the troughs 47 reduces and the rearward and forward electrical contact springs 15,20 are forced into contact with a rearward or forward bipolar plate 11,22 and a rearward or forward gas diffusion electrode 13,18.

The peaks 45 and troughs 47 of the metal mesh of the rearward and forward electrical contact springs 15,20 create a large number of electrical contact points 51. In some embodiments, the metal mesh is a knitted mesh, i.e. it is made of metal wire (suitable metals include nickel) which is interloped to create an defined pattern of metal wire in the mesh. Having the metal mesh be a knitted mesh allows a degree of control over the properties and structure thereof. FIG. 11 shows a close-up schematic of one such knitted mesh. Such a mesh may have a structure with defined through paths for gas flow. Such a mesh is said to have an ordered structure. This is advantageous over known metal meshes or pads of metal mesh which have a random structure, as such pads may have unintentional dead zones where gas flow is inappropriately restricted. Having a knitted mesh creates a more uniform gas flow path through the mesh, which is advantageous for the operation of the fuel cell. Knitted meshes are known in electrolysers for producing halogens (see e.g. U.S. Pat. No. 4,530,743), and generic knitted metal wire meshes are available from suppliers such as Boegger or Knitmesh. The close fit of the rearward and forward electrical contact springs 15,20 within the apertures 21, 29, 35,41 in the flow plates 5,6,8,9 presents the maximum number of electrical contact points 51 to the rearward and forward bipolar plates 11, 22 and to the rearward and forward gas diffusion electrodes 13,18.

In use, an electrical connection is made between an electrical supply (not shown) and the electrical connector 12 of each of the rearward and forward bipolar plates 11,22 of each electrochemical cell 3 within the fuel cell stack 1. An electrical current is applied to the rearward and forward bipolar plates 11,22 and then to the rearward and forward gas diffusion electrodes 13,18 via the electrical contact points 51 on the rearward and forward electrical contact springs 15,20.

The rearward and forward electrical contact springs 15,20 are made from metal wires 57, knitted into a rectangle of multiple strands and formed into corrugations, as shown in FIG. 8. The diameter of the wire strands is typically between 0.05 mm and 0.25 mm and the spacing between the strands will be between 1 and 10 mm. The corrugations 43 are designed so that the forward and rearward electrical contact springs 15,20 apply a compressive pressure in a range of between 150 and 300 g/cm² between the rearward and forward bipolar plates 11,22 and the forward and rearward gas diffusion electrodes 13,18. The compressive pressure is optimised to provide a good electrical contact between the electrical contact points 51 and the forward and rearward gas diffusion electrodes 13, but without the compressive pressure being at a level that would deform the forward and rearward gas diffusion electrodes 13 to such an extent that they become damaged. The electrode support 14 is a mechanical support that resists the compressive pressure applied by the forward and rearward electrical contact springs 15, 20 to the forward and rearward gas diffusion electrodes 13,18 thereby helping to ensure that the deformation of the forward and rearward gas diffusion electrodes 13,18 is kept within acceptable levels. The electrode support 14 is provided with a number of support bosses (not shown) that are spaced apart from each other and provide adequate support to the gas diffusion electrodes. The contact area between the bosses and the surface of the rearward and forward gas diffusion electrodes 13,18 is minimised, the bosses provide minimum disruption to the flow of electrolyte through the electrolyte chamber 40. The spacing of the bosses is between 0.5 cm and 5 cm.

The forward and rearward gas diffusion electrodes 13 have a sandwich construction of three layers, as shown in FIG. 9. A first outer layer 49 is an electrically conductive surface formed by a metal mesh, there is a middle layer 53 and the second outer layer 55 is a catalyst layer. In use, the first outer layer 49 faces outwardly, away from the electrolyte chamber 40 and is brought into contact with the rearward electrical contact spring 15. The second outer layer 55 faces inwardly, towards the electrolyte chamber 40 and is brought into contact with electrolyte within the electrolyte chamber 40.

FIG. 10 illustrates an example electric vehicle (EV) charging system 200 comprising a charging terminal 210, to which an electric vehicle (not shown) can be electrically connected by a cable 212, a fuel cell stack 1 of electrochemical fuel cells 3 is connected to a balance of plant and power electronics 240 as disclosed herein, a battery storage system 230 may or may not be connected, either an ammonia cracking system, a hydrogen gas storage system or a direct hydrogen feed from another source 220 is connected via a tube 222 for conveying a hydrogen gas blend, e.g. a blend of hydrogen and nitrogen from the ammonia cracking or hydrogen system 220 to the fuel cell stack 1. Some example EV charging systems 200 may have the aspect of allowing EVs to be charged in remote locations, in which there is little or no access to an electricity grid.

WO2007038132 relates to membrane electrode assemblies having bipolar plates, including cathode contact arrays between the BSPs and the cathode side of the MEAs. US2002022382 relates to compliant electrical contacts for membrane fuel cells, including springs to create contact between the MEA and the bipolar plates. US2002144898 relates to PEM fuel cells having bipolar plates with a spring-like porous pad of graphite fibres in contact with the outer face of anodes, used to define a fluid cavity. JPH01313855 relates to solid oxide fuel cells having a flexible and conductive foam metal, metal felt, or a metal moulded body therein. US2007190391 relates to solid electrolyte fuel cells having an undulating planar element between the cathode and interconnector. U.S. Pat. No. 4,530,743 relates to an electrolyser for the production of halogens which used a metal knitted mesh to provide electrical conductivity across the liquid electrolyte chamber.

None of the abovementioned publications recite an electrochemical cell having the advantageous features of the present invention.

1. An electrochemical cell (3) comprising at least one resilient electrical conduction member sub-assembly (10,16), the resilient electrical conduction member sub-assembly (10,16) comprising a first flow plate (5,9) with a first electrical contact aperture (21,41) and a second flow plate (6,8) with a second electrical contact aperture (29,35), wherein the first flow plate (5,9) and the second flow plate (6,8) are in abutment with each other, a bipolar plate (11,22) with an electrically conductive surface, the bipolar plate (11,22) covering the first electrical contact aperture (21,41) in the first flow plate (5,9), and a first fluid tight seal (75,77) provided around the bipolar plate (11,22), so that no fluid can pass through the first electrical contact aperture (21,41), an electrode (13,18), the electrode (13,18) covering the second electrical contact aperture (29,35) in the second flow plate (6,8), a fluid chamber (17,19) created by the first flow plate (5,9), the second flow plate (6,8), the bipolar plate (11,22) and the electrode (13,18), the fluid chamber (17,19) having an inflow duct (59,63) and an outflow duct (61,65) which each pass through at least one of the first flow plate (5,9) and the second flow plate (6,8), and a resilient electrical conduction member (15,20) located within the fluid chamber (17,19) in a fluid path between the inflow duct (59,63) and the outflow duct (61,65) so that in use, a fluid can flow between the inflow duct (59,61) and the outflow duct (61,65) through the resilient electrical conduction member (15,20), the resilient electrical conduction member (15,20) has a first side (45,47) that is in electrically conductive contact with the bipolar plate (11,22) and a second side (45,47) that is in electrically conductive contact with the electrode (13,18), such as to allow an electric current to flow between the bipolar plate (11,22) and the electrode (13,18), and the first side (45,47) and the second side (45,47) are each provided with a plurality of electrical contacts (51), wherein the resilient electrical conduction member (15,20) is compressed between the bipolar plate (11,22) and the electrode (13,18), so that the electrical contacts (51) are held against the electrically conductive surface of the bipolar plate (11,22) and the electrode (13,18).

2. An electrochemical cell (3) as claimed in claim 1, wherein the resilient electrical conduction member (15,20) is made from an elastically compressible metal mesh.

3. An electrochemical cell (3) as claimed in claim 2, wherein the elastically compressible metal mesh is a knitted mesh, having an ordered structure.

4. An electrochemical cell (3) as claimed in claim 2 or 3, wherein the elastically compressible metal mesh of the resilient electrical conduction member (15,20) is provided with corrugations arranged so that the peaks (45) of the corrugations are located on the first side and the troughs (47) are located on the second side of the resilient electrical conduction member (15,20), the parts of the metal mesh coincident with the peaks (45) and the troughs (47) forming the electrical contacts (51) and the parts of the metal mesh between the peaks (45) and the troughs (47) forming the attachment element and the flexible conductor.

5. An electrochemical cell (3) as claimed in any one of the preceding claims, wherein the resilient electrical conduction member (15,20) has a first set of electrical contacts (51) on a first side and a second set of electrical contacts (51) on a second side, the first and second sets of electrical contacts (51) having a space between them within which is located an attachment element that attaches the first and second sets of electrical contacts (51) to each other and being electrically connected to each other by a flexible conductor, wherein the resilient electrical conductor (15,20) has at least one fluid flow path passing through the space between its first side and its second side, which, in use enables fluid to flow across the resilient electrical conduction member (15,20).

6. An electrochemical cell according to claim 5, wherein the resilient electrical conduction member (15,20) is a current collector and a flow field.

7. An electrochemical cell (3) as claimed in claim 5 or claim 6, wherein the electrical contacts (51), the attachment element and the flexible conductor are all elastically compressible.

8. An electrochemical cell (3) as claimed in claim 6 or 7, wherein the electrical contacts (51), the attachment element and the flexible conductor are all elastically compressible and are all formed from an electrically conductive material.

9. An electrochemical cell (3) as claimed in claim 8, wherein the electrical contacts (51), the attachment element and the flexible conductor are all elastically compressible, are all formed from an electrically conductive material and are all part of an integral component.

10. An electrochemical cell (3) as claimed in claim 9, wherein the resilient electrical conduction member (15,20) is made from a metal and the fluid flow path is created by a plurality of flow apertures.

11. An electrochemical cell (3) as claimed in any preceding claim, wherein the electrode (13,18) is a flexible electrode.

12. An electrochemical cell (3) as claimed in claim 11, wherein the electrode (13,18) is a flexible gas diffusion electrode.

13. An electrochemical cell (3) as claimed in claim 12, wherein the flexible gas diffusion electrode (13,18) comprises three layers sandwiched together, a first outer layer (49) of an electrically conductive woven mesh, a middle layer (53) and a second outer layer (55) containing a catalyst, the first outer layer (49) being in electrical contact with the resilient electrical conduction member (15,20).

14. An electrochemical cell (3) as claimed in any one of the preceding claims wherein the electrode (13,18) is contained within the electrochemical cell (3) and does not protrude past the external perimeter of the second flow plate (6,8).

15. An electrochemical cell (3) as claimed in any one of the preceding claims, wherein the bipolar plate (11,22) is a non-porous thin plate made from metal.

16. An electrochemical cell (3) as claimed in any preceding claim, wherein the rearward electrolyte flow plate (6) and the forward electrolyte flow plate (8) abut each other and create between them an electrolyte chamber (40) having an electrolyte inflow duct (67) and an electrolyte outflow duct (69), wherein an electrode support (14) is located within the electrolyte chamber (40) and supports the rearward electrode (13) and the forward electrode (18) and is provided with an electrolyte flow path to facilitate the flow of electrolyte across the electrolyte chamber (40) from the inflow duct (67) to the outflow duct (69).

17. An electrochemical cell (3) as claimed in any preceding claim, wherein the flow plates (5,6,8,9) are rectangular, generally flat and have a thickness of 3 mm.

18. An electrochemical cell (3) as claimed in any preceding claim comprising an air flow plate electrical conductor sub-assembly (10), wherein the first flow plate is an air flow plate (5) with a first electrical contact aperture formed by an air chamber aperture (21), the second flow plate is a rearward electrolyte flow plate (6) with a second electrical contact aperture formed by a rearward electrolyte chamber aperture (29), wherein the air flow plate (5) and the rearward electrolyte flow plate (6) are in abutment with each other, wherein the bipolar plate is a rearward bipolar plate (11) covering the air chamber aperture (21) in the air flow plate (5), wherein the electrode is a rearward electrode (13) covering the rearward electrolyte chamber aperture (29) in the rearward electrolyte flow plate (6), the fluid chamber is an air chamber (17) created by the air flow plate (5), the rearward electrolyte flow plate (6), the rearward bipolar plate (11) and the rearward electrode (13), the air chamber (17) having an air inflow duct (59) and an air outflow duct (61) which each pass through at least one of the air flow plate (5) and the rearward electrolyte flow plate (6), and a rearward resilient electrical conduction member (15) located within the air chamber (17) in a fluid path between the air inflow duct (59) and the air outflow duct (61) so that in use, air can flow between the air inflow duct (59) and the air outflow duct (61) through the rearward resilient electrical conduction member (15), the rearward resilient electrical conduction member (15) has a first side (47) that is in electrically conductive contact with the rearward bipolar plate (11) and a second side (45) that is in electrically conductive contact with the rearward electrode (13), such as to allow an electric current to flow between the rearward bipolar plate (11) and the rearward electrode (13) and the first side (47) and the second side (45) are each provided with a plurality of electrical contacts (51), wherein the rearward electrical conduction member (15) is compressed between the rearward bipolar plate (11) and the rearward electrode (13), so that the electrical contacts (51) are held against the rearward bipolar plate (11) and the rearward electrode (13).

19. An electrochemical cell (3) as claimed in any preceding claim comprising a fuel flow plate electrical conductor sub-assembly (16), wherein the first flow plate is a fuel flow plate (9) with a first electrical contact aperture formed by an fuel chamber aperture (41), the second flow plate is a forward electrolyte flow plate (8) with a second electrical contact aperture formed by a forward electrolyte chamber aperture (35), wherein the fuel flow plate (9) and the rearward electrolyte flow plate (8) are in abutment with each other, wherein the bipolar plate is a forward bipolar plate (22) covering the fuel chamber aperture (41) in the fuel flow plate (9), wherein the electrode is a forward electrode (18) covering the forward electrolyte chamber aperture (35) in the forward electrolyte flow plate (8), the fluid chamber is a fuel chamber (19) created by the fuel flow plate (9), the forward electrolyte flow plate (8), the forward bipolar plate (22) and the forward electrode (18), the fuel chamber (19) having a fuel inflow duct (63) and a fuel outflow duct (65) which each pass through at least one of the fuel flow plate (9) and the forward electrolyte flow plate (8), and a forward resilient electrical conduction member (20) located within the fuel chamber (19) in a fluid path between the fuel inflow duct (63) and the fuel outflow duct (65) so that in use, air can flow between the fuel inflow duct (63) and the fuel outflow duct (65) through the forward resilient electrical conduction member (20), the forward resilient electrical conduction member (20) has a first side (45) that is in electrically conductive contact with the forward bipolar plate (22) and a second side (47) that is in electrically conductive contact with the forward electrode (18), such as to allow an electric current to flow between the forward bipolar plate (22) and the forward electrode (18) and the first side (45) and the second side (47) are each provided with a plurality of electrical contacts (51), wherein the forward electrical conduction member (20) is compressed between the forward bipolar plate (22) and the forward electrode (18), so that the electrical contacts (51) are held against the forward bipolar plate (22) and the forward electrode (18).

20. An electrochemical cell (3) as claimed in any one of claims 1 to 19, wherein the first flow plate is an air flow plate (5) and the air flow plate (5) has a bipolar plate recess (25) surrounding the air chamber aperture (21) on its rearward facing side, the rearward bipolar plate (11) is located within the bipolar plate recess (25).

21. An electrochemical cell (3) as claimed in claim 20, wherein the rearward bipolar plate (11) has an electrical connector (12) and the air flow plate has an electrical connector recess (27) within which the electrical connector (12) is located and the rearward facing surface of the bipolar plate (11) is flush with the rearward facing surface of the air flow plate (5).

22. An electrochemical cell (3) as claimed in any preceding claim wherein the rearward electrolyte flow plate (6) and the forward electrolyte flow plate (8) each have an electrode recess (33,39) within which is are located the rearward electrode (13) and the forward electrode (18) respectively.

23. A fuel cell stack (1) comprising a plurality of electrochemical cells (3) according to any one of the preceding claims.

24. A fuel cell stack (1) as claimed in claim 23, wherein at least one bipolar plate (11) is common to two adjacent electrochemical cells (3).

25. A power supply system (200) for charging or powering an electrical device, comprising a fuel cell stack (1) as claimed in claim 24, and a power supply control system (210) electrically connected to the fuel cell stack (1), and having a connector mechanism (212), operable to electrically connect the power supply control system (210) to an electrical device.

26. A power supply system (200) as claimed in claim 25, comprising an ammonia cracker system (220), for processing ammonia to produce hydrogen gas, and a fuel conveyor channel (222) connecting the ammonia cracker system (220) to the fuel cell stack (1), operable to convey the hydrogen gas from the ammonia cracker system (220) to the fuel cell stack (1).

27. An electric vehicle charging station comprising a power supply system (200) according to claim 25 or claim 26.
